(19) United States
(12) Patent Application Publication
(10) Pub. No.: US 2002/0174032 A1
(43) Pub. Date: Nov. 21, 2002

(54) Active data warehouse

(75) Inventor: Chih-Hung Chien, Tao-Yuan Hsien (TW)

Correspondence Address: MERCHANT & GOULD PC, P.O. BOX 2903, MINNEAPOLIS, MN, 55402-0903, US

(73) Assignee: Mitac International Corp., Hsinchu (TW)

(21) Appl. No.: 10/123,809

(22) Filed: Apr. 16, 2002

(30) Foreign Application Priority Data
May 18, 2001 (TW) 090111903

(51) Int. Cl. G06F 17/60

(52) U.S. Cl. 705/26

(57) ABSTRACT

An active data warehouse includes operations between a supplier, a virtual hub and a customer. Data are actively transferred through a backbone for effective response. The process includes data validation, data scrubbing, integration, new data structuring, denormalization and summarization.

### BACKGROUND OF THE INVENTION

1. Field of the Invention

The invention generally relates to an active data warehouse, and more particularly relates to a data warehouse capable of actively transferring information between a supplier, a virtual hub and a customer.

2. Related Art

Data warehousing involves processes for analyzing data, integrating and summarizing variant information from different online operations. It plays an important role in management of planning, transportation, customer service, manufacturing, finance and supply chains. The application and influence of data warehousing are still growing and changing to meet the new requirements of commerce.

Previously, data warehouses emphasized providing accurate and integrated information regarding sales, financial, material, manufacturing or other decision making departments in an enterprise. Information, generally based on products and established by the operation departments, can provide the knowledge employees require for inquiry or observation, such as integration for sales, manufacture or inventory.

However, the updating cycle for information in a conventional data warehouse generally requires at least a week or a month . The inquiry and updating of information are activated in a group-oriented environment, or operated manually, which takes a long time. Therefore, typical applications of conventional data warehouses work with only a few instant processes. Customer classification, inventory control, delivery flow, profit count, predictive response modeling or other evaluations and analyses have to be operated as a batch, and do not allow for instant feedback to the operation system for making better decisions.

In other words, the best way to increase the value of data warehouses is to directly provide useful information for assisting the decision-making of an enterprise. Conventional applications of data warehouses are usually limited to strategic evaluation, such as long-term trend analysis or customer analysis. It is not easy to judge the value of these evaluations, though they are clearly important. When the result of strategic analysis is transformed into an applicable decision, the value can then be weighed. Conventional data warehouses can provide decision assistance on price, market orientation, strategic business planning, and the like. But for obtaining greater value, rapid assistance on decision making that is of a broader scope is necessary, as this is not fully provided by conventional data warehouses. Enterprises now require more active functions in management and operations.

New data warehouses will technically expand their application range and promptly provide evaluation results for online users. The combination of a large database, complicated inquiry functions of conventional decision assistance methods and the response time requirements in conventional trade processing systems is required. In obtaining information, the warehouse has to instantly respond. Because no customer interface is provided in conventional inventory management systems , the supplier has to input sales and inventory data of the customers and simultaneously manage the information of both the customers and the supplier itself. This is caused by the lack of information of material flow and a worsening cycle of quality of the material flow.

A successful data warehouse application must integrate realistic warehouse management and improve its functions for generating more contributions to the enterprise. An active data warehouse is therefore a challenge for improving warehouse management. The major challenge of an active data warehouse is online evaluation for simulated trading variants corresponding to the instant requirements of the supplier, the virtual hub and the customer.

### SUMMARY OF THE INVENTION

The object of the invention is to provide an active data warehouse established between a supplier, a virtual hub and a customer. The data warehouse actively transfers information through a network backbone. The process includes the following steps. The customer sends a purchase order (PO) to the supplier. The supplier replies to the customer with a PO response. Before delivering the material, the supplier sends an advance shipping notice (ASN) to the virtual hub. The virtual hub then sends a notice to the customer indicating the quantity it received according to the advance shipping notice. The customer replies with a material demand to the virtual hub. The virtual hub then delivers the material to the customer, and sends a material outbound notice to the customer and the supplier. After receiving the outbound notice, the customer sends a debt note to the supplier. The supplier checks the debt note and sends an invoice to the customer to request payment. Then, the information and material transfer is finished.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given hereinbelow. However, this description is for purposes of illustration only, and thus is not limitative of the invention, wherein:

FIG. 1 is a schematic diagram showing the operation of an active data warehouse according to the invention;

FIG. 1A is a schematic diagram showing the structure of data exchange in an embodiment of the invention; and

FIG. 2 is a flowchart of the operations between supplier, virtual hub and customer in an embodiment of the invention.

### DETAILED DESCRIPTION OF THE INVENTION

The invention provides an active data warehouse capable of actively transferring information between a supplier, a virtual hub and a customer. The active data warehouse provides a solution for electronic trading. It helps in every step of material ordering, delivery, import and export affairs, tracing orders and customer service. The processes require complex analysis of data transfer and interchange in electronic trading. The data warehouse helps interactions between the customer and the supplier. It handles the specific demands from the start of the trade, obtains any accessible background information, prior orders, inquiry records and other information, and makes the trade interaction smoother and easier.

The active data warehouse of the invention integrates inventory management and decisions of routine operation. A method called “event-based triggering” is the most effective method for handling the operation. The concept and object of event-based triggering is to apply quantified decision-making techniques to analysis of business events, and to actively generate triggering signals for responses to the events.

The active data warehouse of the invention is an application of event-based triggering. When detecting material shortage or material excess, it will actively provide actions for improving stock, handling material transfer, and processing the order and bill to achieve an optimal state.

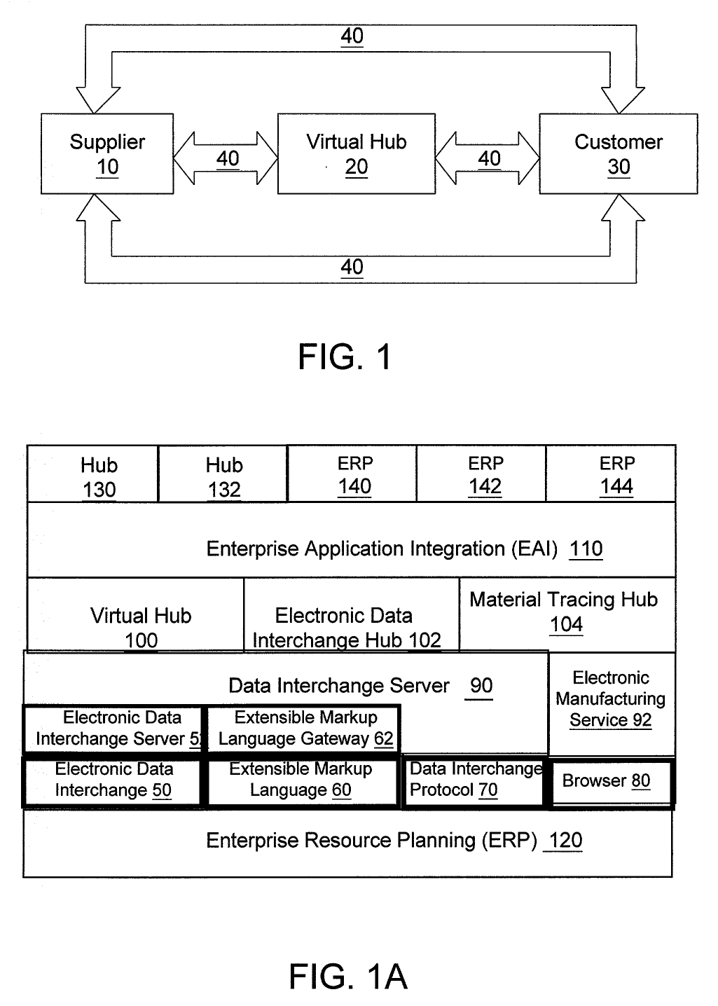

As shown in FIG. 1, an active data warehouse at least includes operations between a supplier 10, a virtual hub 20 and a customer 30. Data are transferred through a backbone 40. The data are transformed and inputted through an active data process of the invention for an effective response. The process includes data validation, data scrubbing, integration, new data structuring, structure denormalization and summarization.

In regard to data storage, the active data warehouse of the invention is a large database that includes current and past data of the whole company. The difference between a conventional database and the active data warehouse is the design concept. A conventional relative database for trading is mainly a transaction system for processing the trade. It emphasizes the speed and stability of data input, deletion and modification. And, based on the management capability of the database system and the transaction log, a large amount of data exchange and modification can be processed safely.

On the other hand , the object of the active data warehouse of the invention is not only to process data input, deletion and modification. The major concept of the active data warehouse process is the ability to analyze a great amount of data and instantly transfer information. FIG. 1A illustrates the structure of data exchange in an embodiment of the invention. A standardized operational system compatible with different systems is used. Data transmission protocols, such as electronic data interchange (EDI) 50, extensible markup language (XML) 60, file transfer protocol (FTP) 70 or browser 80, are used to provide the customer with a web page interface (such as an active server page; ASP) or an application interface (such as XML) for instantly requesting information of inventory and material flow, and downloading or printing relevant forms and inquiry results. If the supplier provides multiple warehouse service, the customer 30 can also use the information for achieving virtual hub functions. By means of data exchange through a data interchange server 90 or an electronic manufacturing service 92, the information of a virtual hub 100, an electronic data interchange hub 102 and a material tracing hub 104 can be utilized. Furthermore, through an enterprise application integration (EAI) interface 110, an enterprise resource planning system (ERP) 120 can be connected with hubs 130 and 132 or other enterprise resource planning systems 140, 142 and 144. Through the aforesaid standardized operational structure, the active process of the invention can be achieved.

In the aforesaid structure, the data transfer protocol from the electronic data interchange (EDI) 50 and the extensible markup language (XML) 60 to the data interchange server 90 are transferred by an electronic data interchange server 52 and an extensible markup language gateway 62 respectively.

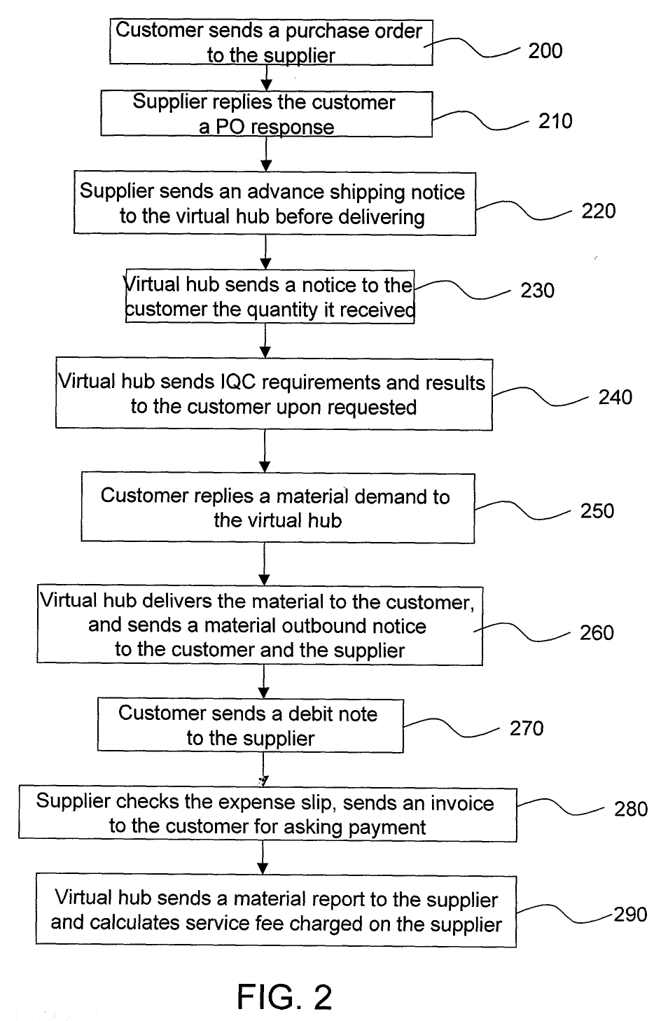

FIG. 2 is a flowchart of operations between the supplier, virtual hub and customer in an embodiment of the invention. Data generated by the supplier, the virtual hub and the customer are exchanged . The data are the subjects of input and output of electronic data exchange in the enterprise resource planning (ERP) systems of the three bodies. The process includes the following steps. The customer sends a purchase order (PO) to the supplier (step 200). The supplier replies to the customer with a PO response (step 210). Before delivering the material, the supplier sends an advance shipping notice (ASN) to the virtual hub (step 220). The virtual hub then sends a notice to the customer indicating the quantity it received according to the advance shipping notice (step 230). According to the customer's request, the virtual hub will send the specifications and results of incoming quality control of the material (step 240). The customer simulates purchasing with the available material of the virtual hub and replies with a material demand to the virtual hub (step 250). The virtual hub then delivers the material to the customer, and sends a material outbound notice to the customer and the supplier (step 260). After receiving the outbound notice, the customer sends a debit note to the supplier (step 270). The supplier checks the debit note and sends an invoice to the customer requesting payment (step 280). Meanwhile, the virtual hub sends a material report to the supplier, and calculates the service fees charged to the supplier (step 290). If necessary, the supplier can inform the customer of the specific stock prepared for the customer for the customer to simulate purchase.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A process for an active data warehouse, established among a supplier, a virtual hub and a customer, to actively transfer data via a backbone, comprising steps of:
sending a purchase order from the customer to the supplier;
replying a purchase order response from the supplier to the customer;
sending an advance shipping notice from the supplier to the virtual hub before the supplier delivers the material;
sending a notice from the virtual hub to the customer the quantity the virtual hub received according to the advance shipping notice;
replying a material demand from the customer to the virtual hub;
delivering the material from the virtual hub to the customer, and sending a material outbound notice to the customer and the supplier;
sending a debit note from the customer to the supplier; and
checking the debit note and sending an invoice from the supplier to the customer for asking the payment after the supplier receives the outbound notice.

2. A process for an active data warehouse according to claim 1 further comprises a step of sending the specification and results of incoming quality control of the material from the virtual hub to the customer according to the customer's request.

3. A process for an active data warehouse according to claim 1 wherein the step of replying a material demand from the customer comprises a purchase simulation with the available material of the virtual hub

4. A process for an active data warehouse according to claim 3 wherein the step of replying a material demand from the customer comprises a purchase simulation with the available material provided by a specific hub of the supplier.

5. A process for an active data warehouse according to claim 1 further comprises a step of calculating the services fee charged on the supplier by the virtual hub

6. A process for an active data warehouse according to claim 5 wherein said services fee is recorded in a material report sent from the virtual hub to the supplier.

7. A process for an active data warehouse according to claim 1 wherein said active data is transferred via a web page.

8. A process for an active data warehouse according to claim 1 wherein said active data is transferred via an application interface.

9. A process for an active data warehouse according to claim 1 wherein said active data is transferred via a file transfer protocol.

10. A process for an active data warehouse according to claim 1 wherein said active data is transferred via electronic data interchange.

11. A process for an active data warehouse according to claim 1 wherein said active data is transferred among enterprise resource planning systems of the supplier, the virtual hub and the customer.

12. A process for an active data warehouse, established among a supplier, a virtual hub and a customer, to actively transfer data via a backbone by electronic data interchange, comprising steps of:
sending a purchase order from the customer to the supplier;
replying a purchase order response from the supplier to the customer;
sending an advance shipping notice from the supplier to the virtual hub before the supplier delivers the material;
sending a notice from the virtual hub to the customer the quantity the virtual hub received according to the advance shipping notice;
replying a material demand from the customer to the virtual hub;
delivering the material from the virtual hub to the customer, and sending a material outbound notice to the customer and the supplier;
sending a debit note from the customer to the supplier; and
checking the debit note and sending an invoice from the supplier to the customer for asking the payment after the supplier receives the outbound notice.

13. A process for an active data warehouse according to claim 13 further comprises a step of sending the specification and results of incoming quality control of the material from the virtual hub to the customer according to the customer's request.

14. A process for an active data warehouse according to claim 12 wherein the step of replying a material demand from the customer comprises a purchase simulation with the available material of the virtual hub.

15. A process for an active data warehouse according to claim 14 wherein the step of replying a material demand from the customer comprises a purchase simulation with the available material provided by a specific hub of the supplier.

16. A process for an active data warehouse according to claim 12 further comprises a step of calculating the services fee charged on the supplier by the virtual hub

17. A process for an active data warehouse according to claim 16 wherein said services fee is recorded in a material report sent from the virtual hub to the supplier.

18. A process for an active data warehouse according to claim 12 wherein said active data is transferred via one in a group of a web page and an application interface.

19. A process for an active data warehouse according to claim 12 wherein said active data is transferred via a file transfer protocol.

20. A process for an active data warehouse according to claim 12 wherein said active data is transferred among enterprise resource planning systems of the supplier, the virtual hub and the customer.
